(19) United States
(12) Patent Application Publication
(10) Pub. No.: US 2013/0178960 A1
(43) Pub. Date: Jul. 11, 2013

(54) SYSTEMS AND METHODS FOR REMOTE MONITORING OF EXERCISE PERFORMANCE METRICS

(71) Applicant: University of Washington through its Center for Commercialization, Seattle, WA (US)

(72) Inventors: Florence H. Sheehan, Mercer Island, WA (US); Mark D. Anderson, Blaine, WA (US); Edward L. Bolson, Redmond, WA (US); Brent M. George, Mercer Island, WA (US)

(73) Assignee: University of Washington through its Center for Commercialization, Seattle, WA (US)

(21) Appl. No.: 13/738,639

(22) Filed: Jan. 10, 2013

Related U.S. Application Data
(60) Provisional application No. 61/585,115, filed on Jan. 10, 2012.

(51) Int. Cl. G06F 17/40

(52) U.S. Cl. CPC G06F 17/40
USPC 700/91

(57) ABSTRACT

The present technology describes various embodiments of systems and methods for remote monitoring of exercise performance metrics. In several embodiments, for example, a method of evaluating an exercise performed by a patient includes providing the patient with a pre-recorded avatar showing an exemplary instance of a prescribed exercise. The method further includes sensing the patient's movement during an exercise session and generating a real-time avatar based on the sensing. The pre-recorded avatar can be overlaid with the real-time avatar. The graphic overlay readily shows the patient whether and where his motion and/or body position deviate from the prescribed exercise. The overlay can be made in real time. In several embodiments, the patient's independently-recorded avatar and/or performance metrics are transmitted to the exercise prescriber to monitor the fidelity with which the patient is able to reproduce the exercise outside the prescriber's supervision.

### CROSS-REFERENCE TO RELATED APPLICATION

This application claims the benefit of U.S. Provisional Patent Application No. 61/585,115, filed Jan. 10, 2012, which is incorporated herein by reference in its entirety.

### TECHNICAL FIELD

The present technology is generally directed to systems and methods for remote monitoring of exercise performance metrics.

### BACKGROUND

Physical therapy is aimed at identifying and maximizing a person's movement potential within the spheres of promotion, prevention, diagnosis, treatment/intervention, and rehabilitation. The physical therapist assesses the physical source of a patient's problem and prescribes exercises that aid in healing and rehabilitation. Exercises may also be prescribed by physicians, such as sports medicine and rehabilitation specialists, occupational therapists, nurses, physician assistants, other health care providers, and trainers.

For patients to benefit, however, they must adhere to the exercise prescription and perform the exercise regularly, consistently, and with the correct technique. Patients are typically instructed to perform their prescribed exercise at home between their physical therapy clinic visits. However, it is often difficult for patients to recall the proper movement required for their prescribed exercise, and to judge whether they are accurately replicating that movement. Commercial products have been developed for tracking a patient's body utilizing body sensors and/or imaging, but they are expensive and focused on competitive athletes or on specific medical conditions such as stroke rehabilitation. Such products only enable assessment of exercise “correctness” when the patient is in the clinic or under supervision by the exercise prescriber. Accordingly, there is a need for methods to improve physical therapy instruction and ensure the fidelity with which a patient reproduces a prescribed exercise at home or other location remote from the exercise prescriber.

### BRIEF DESCRIPTION OF THE DRAWINGS

FIG. 1 is a schematic illustration of a patient performing an exercise with the use of an exercise monitoring system in accordance with embodiments of the technology.

FIG. 2A is a schematic illustration of a skeletal avatar representing a patient exercising in accordance with embodiments of the technology.

FIG. 2B is a schematic illustration of a ball-and-stick figure avatar representing a patient exercising in accordance with embodiments of the technology.

FIG. 3 is a schematic illustration of a patient performing a prescribed exercise in accordance with embodiments of the technology.

FIG. 4 is a magnified schematic illustration of a monitor displaying a pre-recorded avatar overlaid on a real-time avatar in accordance with embodiments of the technology.

FIG. 5A is a schematic illustration of an avatar recording of a patient's exercise routine in accordance with embodiments of the technology.

FIG. 5B is a schematic illustration of a tracking region overlaid on the avatar recording of FIG. 5A and configured to determine whether the patient's movement falls within a range of acceptability in accordance with embodiments of the technology.

FIG. 6 is a block diagram illustrating a method of recording an avatar of an exemplary instance of a prescribed exercise in accordance with embodiments of the technology.

FIG. 7 is a block diagram illustrating a method employed by a patient of performing an exercise using an avatar recording in accordance with embodiments of the technology.

FIG. 8 is a block diagram illustrating a method of reviewing an avatar recording taken during a patient's independently-performed exercise in accordance with embodiments of the technology.

### DETAILED DESCRIPTION

The present technology describes various embodiments of systems and methods for remote monitoring of exercise performance metrics. In several embodiments, for example, a method of evaluating an exercise performed by a patient includes providing the patient with a pre-recorded avatar showing an exemplary instance of a prescribed static or dynamic exercise. The method further includes sensing the patient's movement (as a change in body position over time) during an exercise session and generating a real-time avatar based on the sensing. The pre-recorded avatar can be overlaid with the real-time avatar. The graphic overlay readily shows the patient whether and where his motion and/or body position deviate from the prescribed exercise. The overlay can be made in real time. In several embodiments, the patient's independently-recorded avatar and/or performance metrics are transmitted to the exercise prescriber to monitor the fidelity with which the patient is able to reproduce the exercise outside the prescriber's supervision.

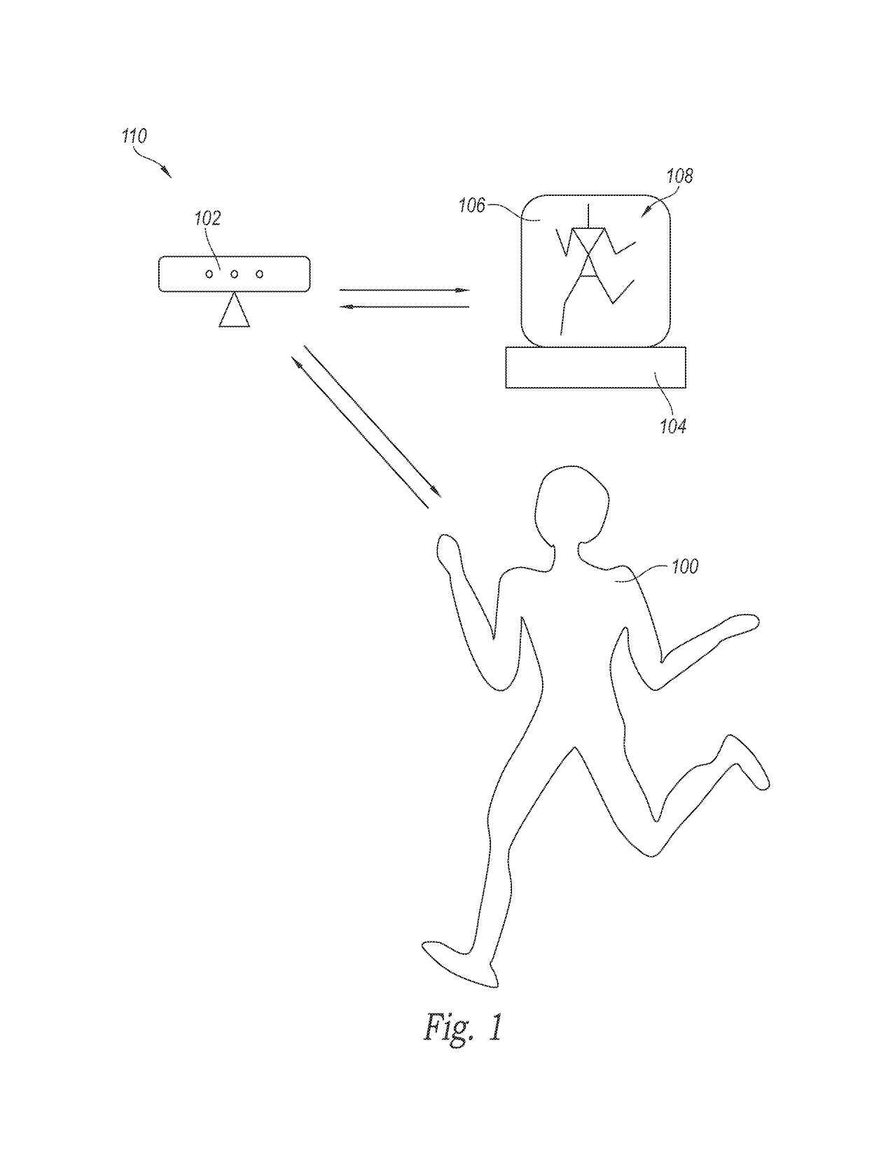

Specific details of several embodiments of the technology are described below with reference to FIGS. 1-8. Other details describing well-known structures and systems often associated with physical therapy, remote monitoring systems, and movement detection systems have not been set forth in the following disclosure to avoid unnecessarily obscuring the description of the various embodiments of the technology. Many of the details, dimensions, angles, and other features shown in the Figures are merely illustrative of particular embodiments of the technology. Accordingly, other embodiments can have other details, dimensions, angles, and features without departing from the spirit or scope of the present technology. A person of ordinary skill in the art, therefore, will accordingly understand that the technology may have other embodiments with additional elements, or the technology may have other embodiments without several of the features shown and described below with reference to FIGS. 1-8.

FIG. 1 is a schematic illustration of an exerciser or patient 100 performing an exercise with the use of an exercise monitoring system 110 in accordance with embodiments of the present technology. In several embodiments, the exercise monitoring system 110 includes a motion sensing device 102 configured to sense the body position of the patient 100 and communicate movement data to a computer 104. For purposes of this disclosure, the term “movement” can refer to static or dynamic movement or body position. For example, the motion sensing device 102 can capture a swing of a tennis racquet (dynamic movement) or a yoga pose (generally static movement). The motion sensing device 102 can capture the movement data as a series of body position points tracked over time. The computer 104 can process, store, and/or transmit the movement data. In several embodiments, the computer 104 can output the movement data to a display or monitor 106.

The motion sensing device 102 can be a customized motion sensing device or can be a commercially available device, such as a console used in motion-sensing video games. For example, in some embodiments, the motion sensing device 102 is the Microsoft Kinect™, and the executable instructions for identifying the patient 100 in the environment and detecting and tracking the patient's skeleton in real time are from the PrimeSense™ Software Development Kit (commercially available from PrimeSense, Ltd., of Tel Aviv, Israel). The PrimeSense™ Software Development Kit, for example, enables tracking of major anatomic landmarks in the body. In other embodiments, however, other hardware and/or software can be employed. In some variations, for example, the motion sensing device 102 utilizes an infrared projector and camera. In still further variations, the patient may be tracked using a plurality of motion sensing devices 102 to improve the accuracy of tracking, particularly tracking of rotational motions and tracking of small body parts. In some embodiments, the motion sensing device 102 wirelessly transmits the movement data to the computer 104.

As will be described in further detail below, the patient movement data can be displayed as numerical data, a visual indicator of the patient's motion, or an indicator comparing the patient's motion to a prescribed exercise regime. For example, in FIG. 1, the monitor 106 displays an avatar 108 generated by the movement data and corresponding to the patient's form. The avatar 108 can move in real time motions corresponding to the patient's motions. For purposes of this disclosure, the term “avatar” refers to any two or three dimensional representation of a human figure recorded at rest and/or during motion, reconstructed from at least one anatomic landmark identified from data acquired by the motion sensing device 102. In further embodiments, the movement data can be output in the form of an audio or visual signal, such as a flash of light or chime if the patient moves outside a predetermined acceptable range for the prescribed exercise regime. The monitor 106 can indicate a visual alert, such as an indicator overlaid on the avatar 108.

In operation, the exercise monitoring system 110 can be used to first record a model or exemplary instance of the patient 100 performing a prescribed exercise. The model avatar can be recorded in the presence of a professional, such as a physical therapist, physician, trainer, etc. to ensure proper patient movement. In some embodiments, the model avatar is selected by the prescriber as the best of several repetitions. The model avatar recording can then be provided to the patient 100 to use during independent physical therapy exercises, such as in the patient's home. The patient 100 can display the model avatar and use the motion sensing device 102 to record a real-time avatar of independently-performed exercises. As will be discussed in further detail below, the model and real-time avatars can be overlaid (e.g., overlaid in real time) to illustrate/alert the patient 100 to movement deviations that fall outside an acceptable threshold, and that a body position or angle should be adjusted. For example, anatomical landmarks (e.g., joints) can be compared between the model avatar and real-time avatar. Deviations between these anatomical landmarks that fall outside an acceptability threshold can trigger an alert to the patient 100 or a notification to the exercise prescriber.

Deviations in body position between the exemplary avatar and the real-time avatar may be computed in terms of a joint angle and/or distance between two anatomic landmarks. A plurality of deviations between the patient's real-time avatar and the exemplary avatar may be communicated to the patient via the graphic display of the overlaid avatars. All recordings of the patient's exercise can be stored and/or transmitted to the exercise prescriber for future review. The patient's independently-recorded avatars can be transmitted by memory device (e.g., thumb drive), or via internet transmissions means. In further embodiments, the patient's real-time avatar recordings are saved to remote server, such as a HIPAA (Health Insurance Portability and Accountability Act)—compliant server. However any other mode of communication of digital data may be employed. In further embodiments, the prescriber is viewing the patient's independent avatar recording in real time, either with the patient or at a remote location.

In various embodiments, every repetition or a sample of repetitions of the exercise are recorded. The recordings can include the avatar of the exercise session, and the date and time that repetition of the exercise was performed. The review of the recordings by the exercise prescriber may be facilitated by screening to select for review those recordings that have deviations exceeding the allowed threshold at one or more anatomic landmarks. The number of exercise repetitions that was performed correctly may be counted. The patient's compliance may be presented in a tabular or graphic mode to facilitate assessment. In some embodiments, the computer 104 sorts the patient's avatar records by severity of deviation to facilitate review. The system 110 can thus be used to measure the fidelity with which a patient reproduces prescribed exercise without supervision from the exercise prescriber, and these tools can assist the exercise prescriber in evaluating the patient's status.

Based on review of the patient's avatar recordings or movement data, the exercise prescriber may alter the prescribed exercise. Examples of adjustments can include a change in the number of repetitions to be performed at a session, change in the resistance against which the patient exerts, change in the speed with which the exercise is performed, change in the range of motion, and change in the angle of posture of a plurality of anatomic landmarks. The exercise prescriber then communicates instructions to the patient regarding his exercise, including alterations. A modified avatar may be transmitted to the patient for subsequent exercise guidance when exercising without supervision of the exercise prescriber.

In further embodiments, the pre-recorded exemplary exercise may be from another point in the patient's history; for example, of the patient at an earlier age or at an earlier stage in a disease process or at a different stage in a treatment regimen. In still further embodiments, the patient's movement can be compared against an expert performing the same exercise. Yet another alternative is to compare a plurality of persons performing the same exercise. In still other embodiments, a range of different size patients are provided as models for performing the exercise and then making an avatar out of these models. The model appropriate to the patient's size and shape is then chosen as the avatar for the patient to compare with his or her real-time avatar doing the independently-performed exercise in the manner described above.

While the exercise routine has been generally discussed in the context of physical therapy, exercise can be any bodily activity that maximizes quality of life and movement potential, or enhances or maintains physical fitness or overall health and wellness. The term “prescribed exercise” refers to a plurality of changes in position and/or orientation of body joints that may be prescribed by a prescriber (e.g., health care provider) to a patient. For example, the systems and methods described can be used for the treatment of patients with disabilities (e.g., gait disturbances), or patients with localized clinical conditions such as hand injuries or carpal tunnel syndrome, or patients with neurological or neuromuscular conditions such as vertigo or dysphagia. Yet another application is in the context of physical activities for cultural enrichment, personal achievement, or art, such as yoga, tai chi, or dance. The exercise can include one or multiple routines or sets of movements.

As will be described in further detail below, for each exercise the exercise prescriber can identify a plurality of anatomic landmarks that should be correctly positioned during exercise. Furthermore the exercise prescriber can define the amount of deviation allowed at each identified landmark and/or can define where a landmark should be positioned at specified time points in the course of the exercise. The exercise prescriber may acquire a plurality of exercises from other sources such as textbooks, courses, educational devices, experts, physicians, among others. The identification of anatomic landmarks that should be correctly positioned in an exercise may also be performed using information from other sources. The threshold for allowable deviation in position and/or angle may also be obtained from other sources. As an alternative, if an exercise prescriber feels the need to modify a previously-developed exercise to meet the particular needs of a patient, then the anatomic landmark identification and allowable deviation may be adjusted during the course of treatment.

Further, while the person performing the exercise has been referred to as a patient, it should be noted that exercise prescription may also be preventive of injury and the person performing the exercise may not be injured or diseased. Likewise, the term “exercise prescriber” refers to physical therapists, physicians such as sports medicine and rehabilitation specialists, occupational therapists, nurses, physician assistants, other health care providers, and trainers. In further embodiments, other types of employers or supervisors can be an exercise prescriber. For example, the systems and methods described herein can be used to train workers to lift heavy loads or perform other physical labor with posture that minimizes injury to the back. In another embodiment, the systems and methods described can be used to train basketball players to land from jumps with posture that reduces risk of anterior cruciate ligament injury.

It should be further noted that the technology disclosed herein may also be applied to teach people ergonomics, such as how to position their bodies to prevent injury during rest or work. Examples include posture while sitting at a desk, in a truck, driving a vehicle, or working at a computer. The technology disclosed herein may further be applied to assist people in improving their performance at a sport, athletic competition, or other physical endeavor. For example, the technology disclosed herein may assist in improving body position during weight lifting or other sports such as skiing, tennis, basketball, baseball, soccer, running, football, or hockey. Yet another application is to improve or maintain function in the elderly, e.g., balance exercises and exercises to maintain or recover independence in the activities of daily life, such as getting out of bathtub or chair, standing, walking, dressing, or eating. In still other embodiments, the disclosed technology may be used to train various other persons to properly/more efficiently perform various tasks.

While particular types of electronic components of the system 110 have been described, other embodiments can include other suitable devices. For example, in further embodiments the motion sensing device 102, computer 104, and/or monitor 106 can comprise a single device. These devices can include a processor, traditional input/output components, memory, wired and/or wireless communication components, transmitters, on-the-body motion sensors or pads, or other devices known in the art. For example, the system 110 can include a processor capable of implementing executable instructions for identifying the patient in three dimensions within the physical environment; executable instructions for detecting anatomic landmarks in the patient's skeleton; executable instructions for tracking anatomic locations in the patient's skeleton; executable instructions for displaying patient motion in real time; executable instructions for displaying a previous recording of tracked motion as a visual overlay onto currently tracked motion in real time; executable instructions for aligning and synchronizing previous recordings and a currently tracked motion; executable instructions for identifying a plurality of anatomic landmarks to be aligned and synchronized between a previous recording and a currently tracked motion; executable instructions for specifying thresholds for allowable deviations in distance and/or angle for a plurality of anatomic landmarks being aligned and synchronized; executable instructions for measuring deviations in distance and angle between a plurality of anatomic landmarks in the previous recording and the corresponding landmarks in the currently tracked motion, and comparing such deviations to the corresponding thresholds for allowable deviations during exercise; and/or executable instructions for screening stored traced motion to select those repetitions of the prescribed exercise that deviate beyond a specified threshold.

The system 110 can further include a display unit for displaying the patient's tracked motion, a display for reporting to the patient the occurrence and magnitude of any and all deviations if and when they exceed the specified threshold(s), and/or a display for informing the patient graphically the trajectory of a tracked joint and its allowable deviation. In some embodiments, the monitor 106 comprises a handheld monitoring device, such as a smart phone, notebook, or tablet.

The system 110 can further include means to compute or display a graphic report or metrics of exercise fidelity that can be used to inform the exercise prescriber of the patient's adherence to the exercise prescription. Such a graphic report can comprise a plurality of adherence metrics including any or all of the following: the frequency of exercise performed, the duration of exercise sessions, the number of repetitions of the exercise performed at a session, and the magnitude of deviations. Such a graphic report can further have the capability of displaying an avatar recording of a patient's independently-recorded exercise repetition that corresponds to a deviation selected on the report.

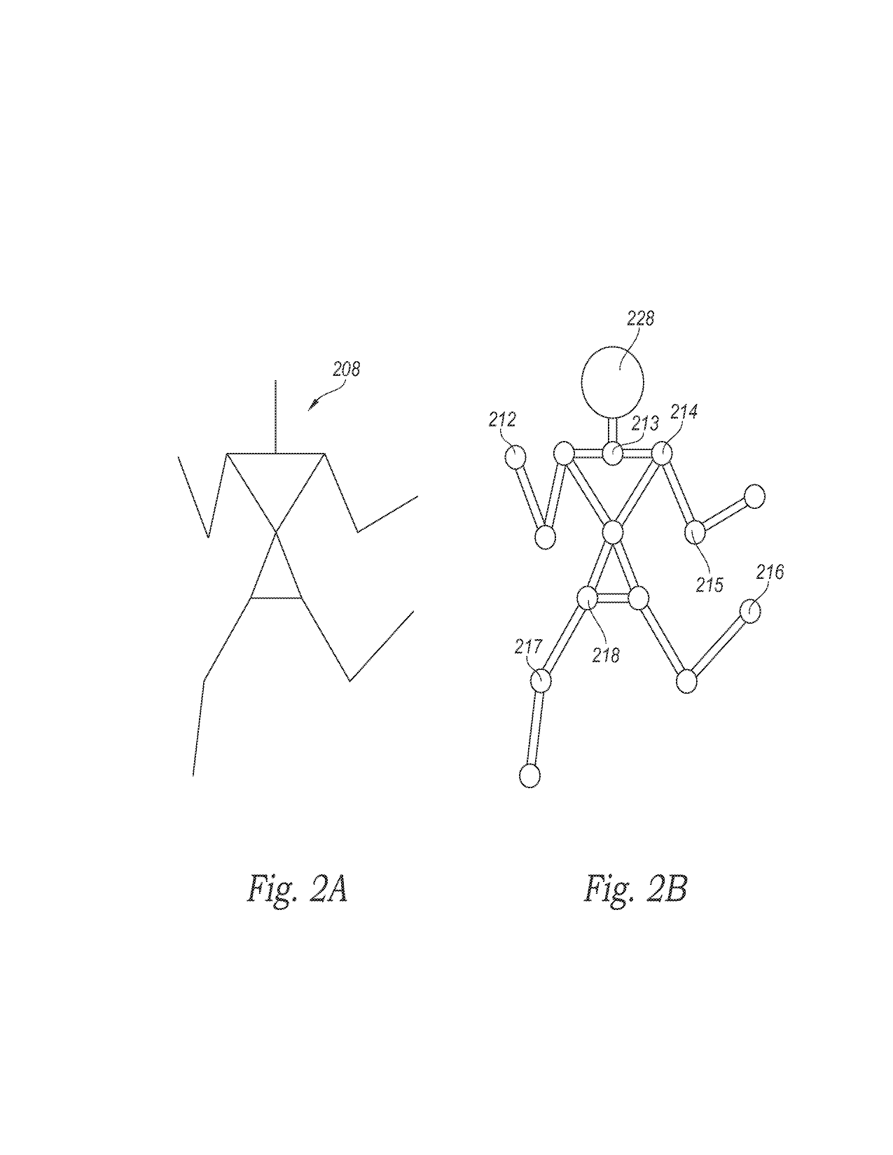

FIG. 2A is a schematic illustration of a patient outline or skeleton avatar 208 representing a patient exercising in accordance with embodiments of the technology. FIG. 2B is a schematic illustration of a ball-and-stick figure avatar 228 representing a patient exercising in accordance with embodiments of the technology. Both the skeleton avatar 208 and stick figure avatar 228 represent the patient's motion at a plurality of joints including wrist 212, neck 213, shoulder 214, elbow 215, ankle 216, knee 217, and hip 218.

The term “skeleton” refers to a form of avatar in which the three dimensional representation of the human figure comprises connected line segments. The term “ball-and-stick figure” refers to another form of avatar in which the three dimensional representation of the human figure comprises tubes connected by spheres. The avatars may be used to graphically display the whole body of an individual or alternatively, focused on a region of the body. For example, the avatar could be limited to visualization of the shoulder, back, neck, knee, extremity (e.g., arm or leg), head, abdomen, or chest, or a plurality of regions of the body. As a variation, smaller joints such as those in the hand may be traced. The form of the avatar is not restricted to the skeleton or to the ball and stick model. Rather, any of a plurality of two- or three-dimensional models of the human figure may be employed to represent body position and angle during exercise.

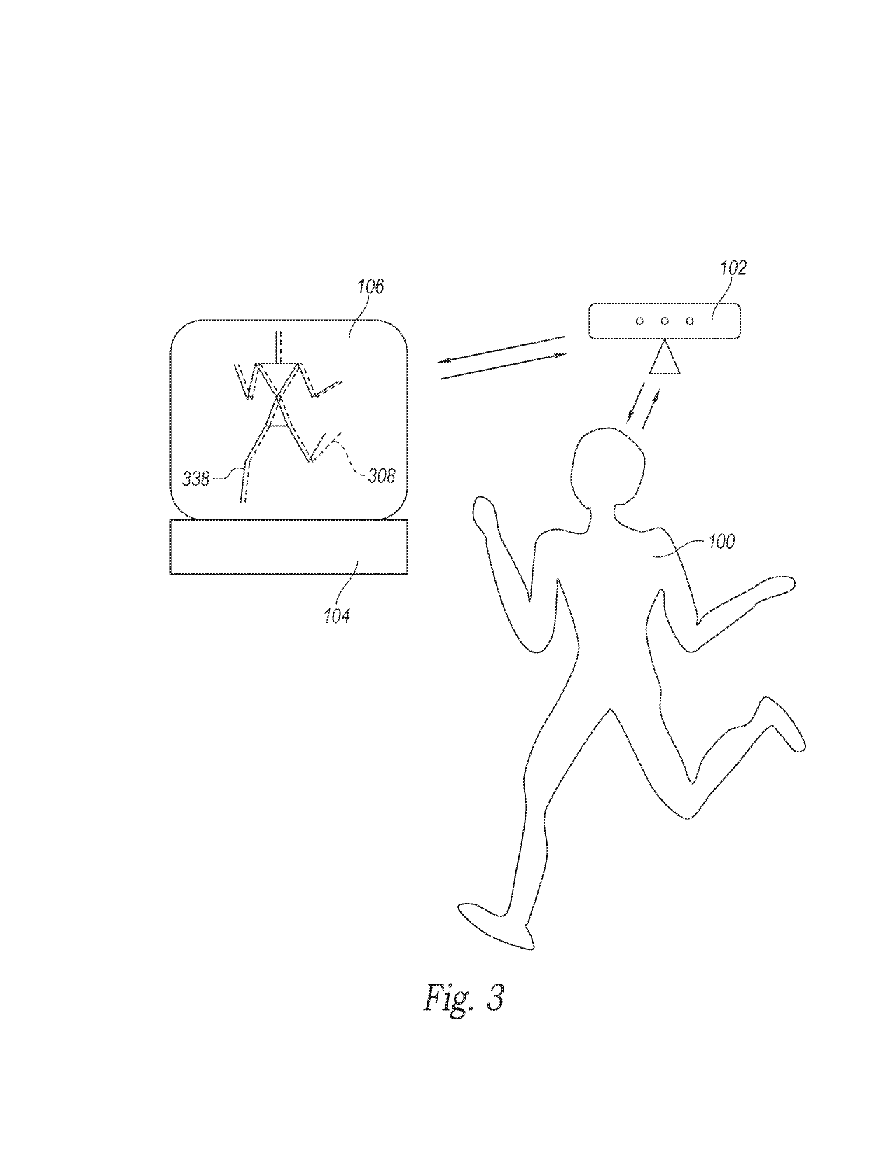

FIG. 3 is a schematic illustration of the patient 100 independently performing a prescribed exercise in accordance with embodiments of the technology. In several embodiments, the prescribed exercise is performed outside the direct supervision of an exercise prescriber. The motion sensing device 102 receives patient movement data in the manner described above, and transmits that data to the computer 104. The computer 104 transforms that data into a real-time patient avatar 308 displayed on the monitor 106. The real-time avatar 308 can be overlaid onto a pre-recorded avatar 338. As described above, in several embodiments, the pre-recorded avatar 338 has been recorded as an exemplary avatar indicating ideal motion in the prescribed exercise routine. The overlaid avatars 308, 338 can help guide the patient toward a more correct body position and orientation.

While the avatar 308 created from a patient's independent exercise routine is described as a “real-time” display, it can alternately be a delayed display or can be recorded for the patient or a practitioner to review at a later time. For example, if the prescribed exercise is too rapid for the patient to follow the avatar visually, then the display and metrics of fidelity may be reviewed retrospectively by the patient following completion of a repetition of the exercise to obtain biofeedback to guide the patient how to perform the next repetition more correctly. For example, swinging a tennis racket is a rapid motion that may not be evaluated visually during the swing, but retrospective review of a just completed live swing overlaid onto a well executed swing may be performed. In another variation, the display may be placed at another location more easily seen by the patient for exercises performed in positions where the patient is not facing a wall monitor. For example, an exercise performed lying prone on an exercise ball may be displayed to the patient on a monitor placed on the floor under the patient's face.

While the pre-recorded avatar 338 and real-time avatar 308 are shown in different line types, in other embodiments the two avatars can be differentiated by different colors, different shapes, or other differentiating feature so that any deviation in motion between the ideal pre-recorded exercise and the real-time exercise can be readily appreciated by the patient and/or practitioner.

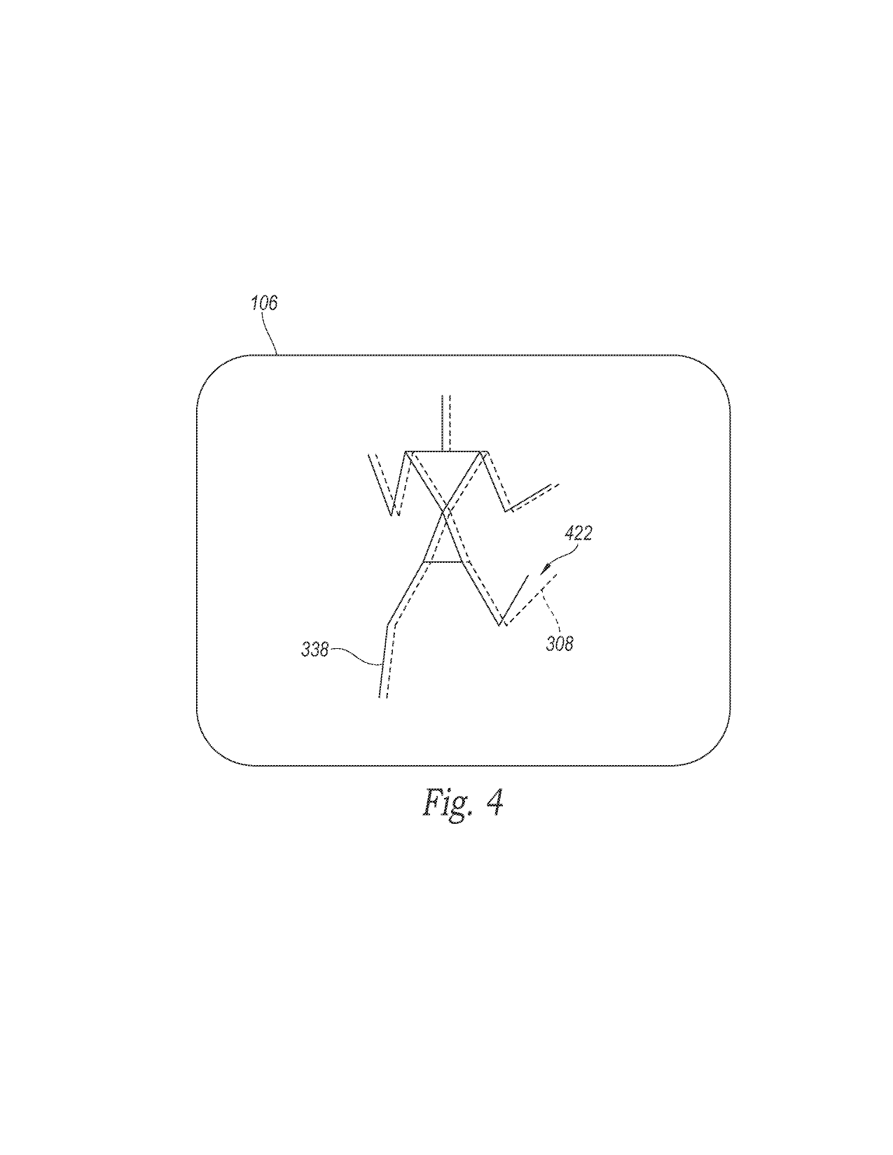

FIG. 4 is a magnified schematic illustration of the monitor 106 of FIG. 3 outputting the overlaid pre-recorded avatar 338 and real-time avatar 308 in accordance with embodiments of the technology. The two avatars 308, 338 are overlaid so that a deviation in the exercise being performed by the patient can be immediately detected as to location and timing from the failure of the avatars 308, 338 to exactly overlap (e.g., at deviation region 422). The two avatars can be synchronized (e.g., in space and/or time). In some embodiments the patient 100 performs the prescribed exercise at the same speed as when recorded by the exercise prescriber. In other embodiments, the patient may perform the exercise at a different speed either voluntarily or involuntarily, and the motion sensing device will track his or her body motion and relate it to the motion in the correctly performed exercise.

The patient may be notified of deviations by any means (e.g., audio/visual) referenced above. For example, the notification can be made by numeric distance and/or angle metrics displayed on the monitor, flashing of a graphic indicating the joint trajectory and allowable deviation, voice, and non-verbal sounds. In further embodiments, tactile indicators are used (e.g., vibration pads on the errant joint). The exercise prescriber may assign a priority to certain anatomic landmarks whose position and/or angle are more important to reproduce correctly. Such priority can be communicated to the patient by any of a plurality of graphic means including but not limited to assigning colors or brightness to the selected anatomic landmarks.

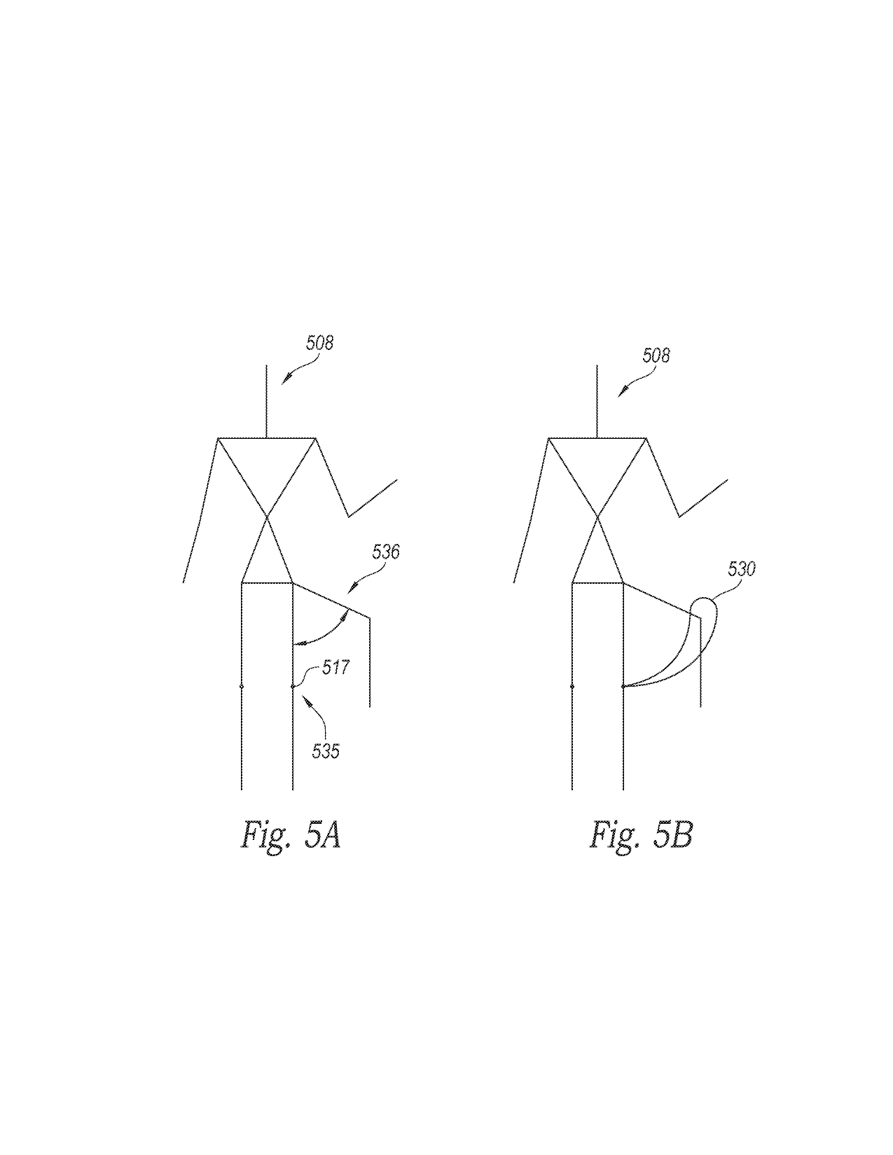

FIG. 5A is a schematic illustration of an avatar 508 of a patient's exercise routine in accordance with embodiments of the technology. The avatar 508 is shown with a knee 517 in a first or starting position 535 and after movement to a second position 536. FIG. 5B is a schematic illustration of a tracking region 530 overlaid on the avatar 508 and configured to determine whether the patient's movement falls within a range of acceptability in accordance with embodiments of the technology. The tracking region 530 can comprise a shape (e.g., a balloon, cone, etc.) that corresponds to the trajectory of the tracked joint (i.e., the knee 517) and whose radius over that trajectory indicates the limit of the allowed deviation that the tracked joint can exhibit in the exercise. In several embodiments, the range of acceptability is determined as a statistically acceptable degree of deviation from an “ideal” instance of the prescribed exercise regime. As discussed above, the ideal instance of the exercise regime can be recorded in front of a physical therapist or trainer to ensure proper movement.

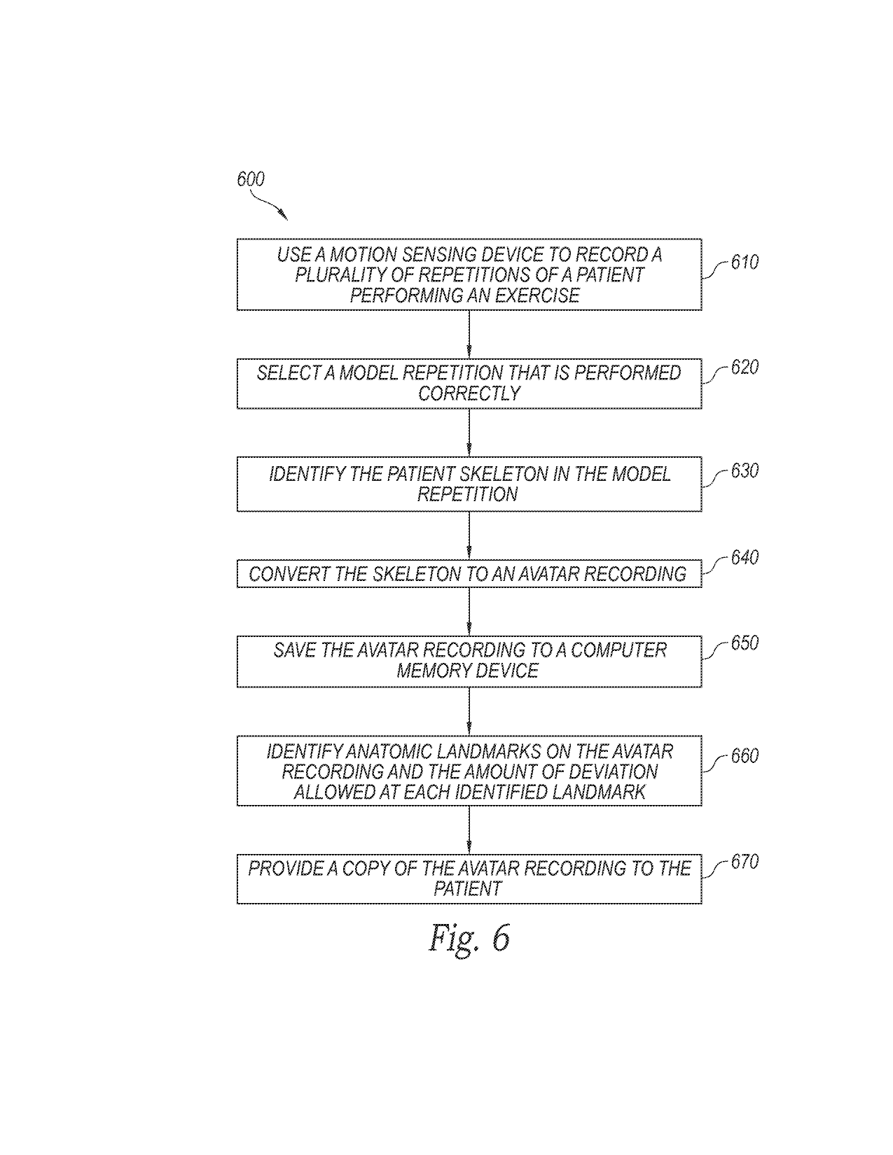

FIG. 6 is a block diagram illustrating a method 600 of recording an avatar of an exemplary instance of a prescribed exercise in accordance with embodiments of the technology. At block 610, the method 600 includes using a motion sensing device to record a plurality of repetitions of a patient performing an exercise. The method 600 then includes, at block 620, selecting a model repetition that is performed correctly per the exercise prescription. At block 630, the patient's skeleton or outline can be selected in the model repetition. At block 640, the patient's skeleton is converted to an avatar recording (e.g., a video). The avatar recording is saved to a computer memory device at block 650. The method 600 can further include identifying anatomic landmarks (e.g., joints) that are to be specifically positioned and monitored during the prescribed exercise regime; the amount of deviation allowed at each identified landmark is likewise identified at block 660. Further, at block 670, a copy of the avatar recording is provided to the patient for use independently of the exercise prescriber.

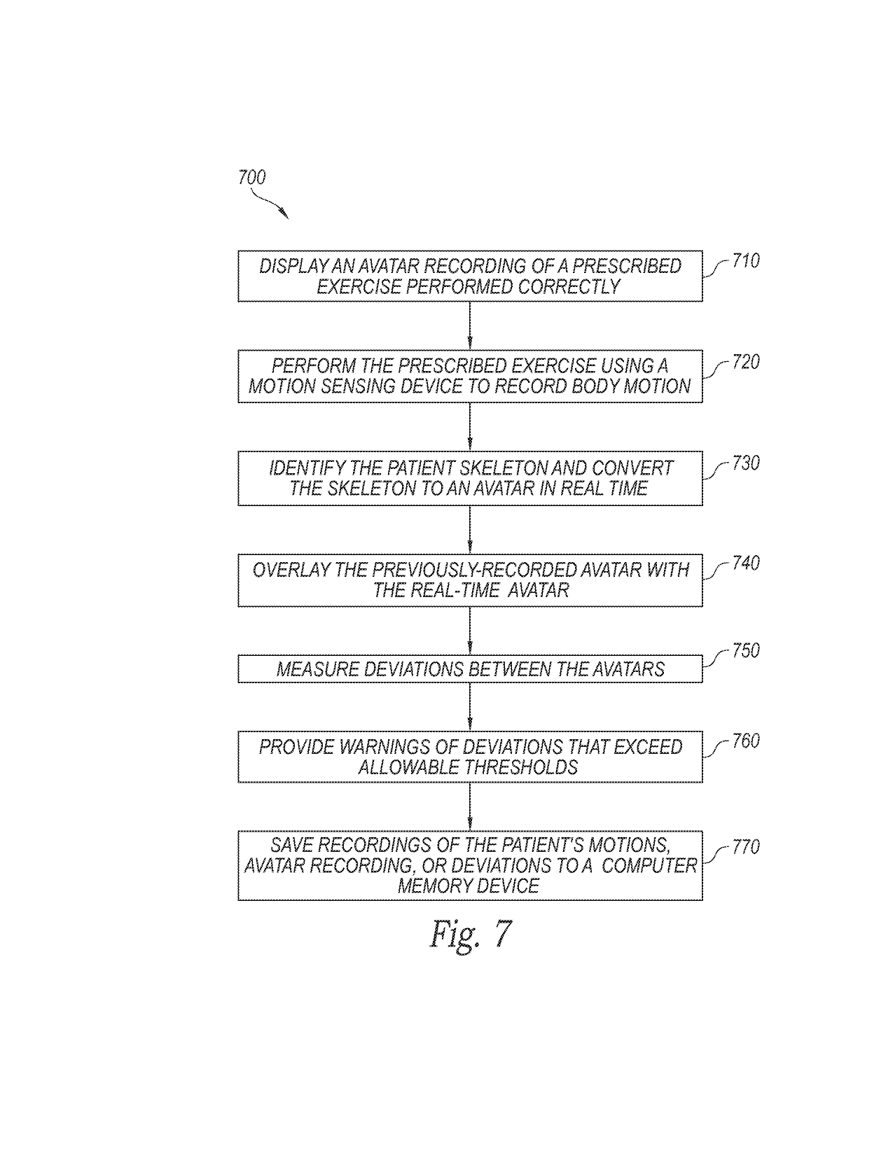

FIG. 7 is a block diagram illustrating a method 700 employed by a patient of performing an exercise using an avatar recording in accordance with embodiments of the technology. In several embodiments, the method 700 is implemented at home or otherwise without the direct supervision of the exercise prescriber. At block 710, the method 700 includes displaying an avatar recording of a model instance of a prescribed exercise preformed correctly. The model recording can be a recording of the patient or another person performing the exercise, or can be a computer-generated recording indicating the ideal exercise motions. At block 720, the method 700 further includes performing the prescribed exercise using a motion sensing device to record the patient's body motion. At block 730, a computing device can be used to identify the patient's skeleton or body outline and convert the skeleton to an avatar in real time. In other embodiments, the skeleton is recorded for later conversion.

At block 740, the method 700 further includes overlaying the previously-recorded model avatar on the real-time avatar (or vice versa). The overlay can be done in real time or at a later time. At block 750, deviations between the two avatars can be measured constantly or at intervals. At block 760, a display or computer system can provide a warning of deviations that exceed allowable thresholds. At block 770, in some embodiments the method 700 includes recording the patient's exercise motions, real-time avatar recordings, and/or deviations to a computer memory device for later review by a trainer, physician, or physical therapist.

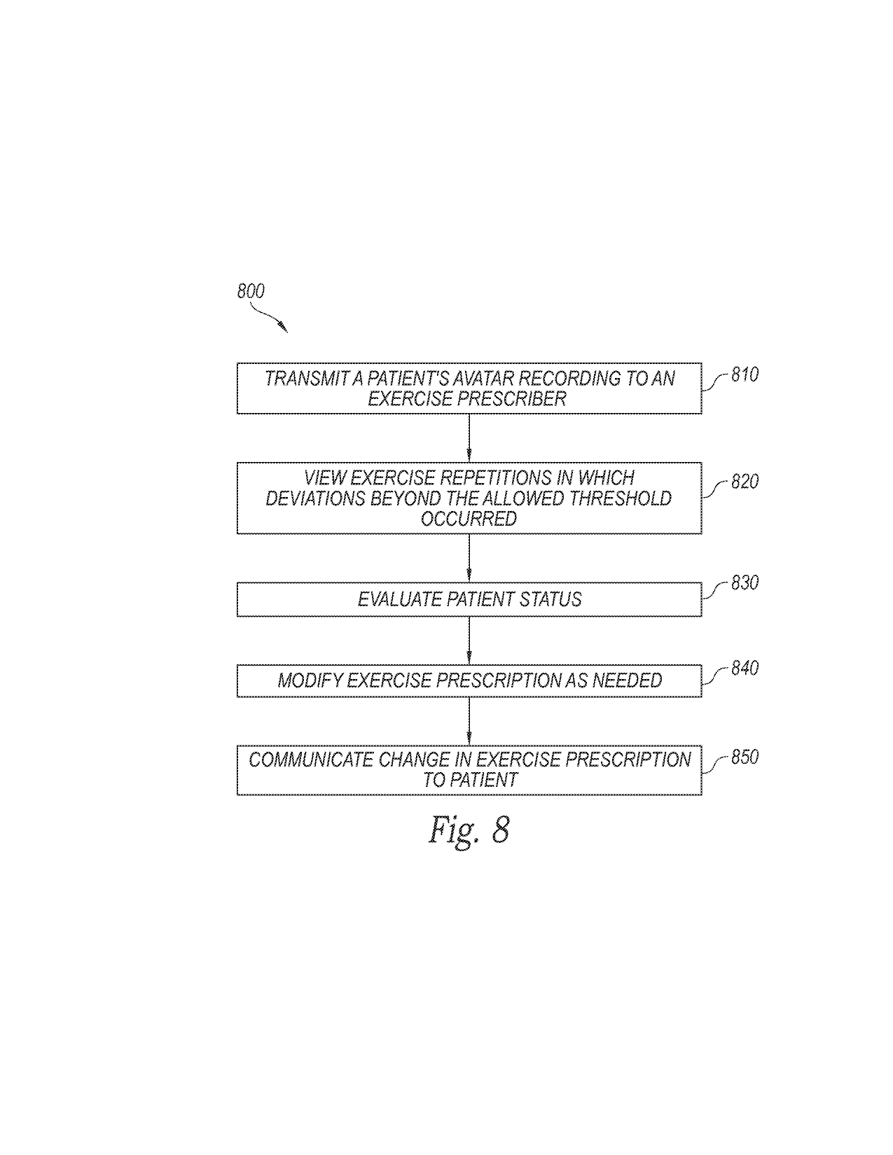

FIG. 8 is a block diagram illustrating a method 800 of reviewing an avatar recording taken during a patient's independently-performed exercise in accordance with embodiments of the technology. The method 800 includes, at block 810, transmitting a patient's avatar recording to an exercise prescriber. The recording can be transmitted via wired or wireless means, or saved and physically transferred on a memory device, such as a thumb drive. At block 820 the method 800 further includes viewing instances of exercise repetitions in which deviations beyond an allowed threshold occurred. The deviations can be identified by the prescriber or can be pre-identified by computer software. The patient status (e.g., physical improvement, mobility, etc.) can be evaluated at block 830. The exercise prescription can optionally be modified as needed at block 840. Finally, the change in the exercise prescription can be communicated and demonstrated to the patient, and a new model avatar can be recorded as necessary at block 850.

From the foregoing it will be appreciated that, although specific embodiments of the technology have been described herein for purposes of illustration, various modifications may be made without deviating from the spirit and scope of the technology. Further, certain aspects of the new technology described in the context of particular embodiments may be combined or eliminated in other embodiments. Moreover, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein. Thus, the disclosure is not limited except as by the appended claims.

I/We claim:

1. A method of evaluating an exercise, the method comprising:
pre-recording a three-dimensional avatar representing an exemplary instance of a prescribed exercise;
generating a three-dimensional real-time avatar of a patient performing the prescribed exercise; and
graphically comparing the pre-recorded avatar and the real-time avatar.

2. The method of claim 1 wherein pre-recording an avatar comprises generating the pre-recorded avatar in the presence of an exercise prescriber.

3. The method of claim 1 wherein graphically comparing the pre-recorded avatar and the real-time avatar comprises overlaying the pre-recorded avatar with the real-time avatar.

4. The method of claim 3, further comprising transmitting the overlaid pre-recorded avatar and real-time avatar to at least one of an exercise prescriber or health care provider.

5. The method of claim 3 wherein overlaying the pre-recorded avatar with the real-time avatar comprises overlaying the avatars as the real-time avatar is being generated.

6. The method of claim 1, further comprising indicating deviation between the pre-recorded avatar and the real-time avatar.

7. The method of claim 6 wherein indicating deviation comprises providing at least one of a visual or audio alert.

8. The method of claim 6 wherein indicating deviation comprises indicating a plurality of regions on the real-time avatar that fall outside a pre-determined acceptable trajectory of the pre-recorded avatar at one or more time points during the exercise.

9. The method of claim 8 wherein indicating a plurality of regions on the real-time avatar that fall outside a pre-determined acceptable trajectory of the pre-recorded avatar comprises indicating an anatomical landmark on the real-time avatar that falls outside an acceptable angle or distance from a corresponding anatomical landmark on the pre-recorded avatar.

10. The method of claim 8, further comprising graphically displaying the acceptable trajectory overlaid on at least one of the real-time avatar or the pre-recorded avatar.

11. The method of claim 6, further comprising generating a report regarding the deviation and transmitting the report to at least one of an exercise prescriber or health care provider.

12. The method of claim 11 wherein transmitting the report to an exercise prescriber or health care provider comprises transmitting the report in a format that allows for selection of the deviation in the report and, upon selection, displaying a recording of the real-time avatar that corresponds to the deviation.

13. A method of exercise instruction, the method comprising:
providing a patient with a pre-recorded avatar;
sensing the patient's movement during an exercise session;
generating a real-time avatar based on the sensing; and
displaying the pre-recorded avatar overlaid with the real-time avatar.

14. The method of claim 13, further comprising identifying deviation between the real-time avatar and the pre-recorded avatar.

15. The method of claim 14, further comprising modifying the exercise regime in response to at least one of the deviation or a patient condition.

16. The method of claim 15, further comprising providing the patient with an updated pre-recorded avatar based on the modifying.

17. The method of claim 14 wherein identifying deviation between the real-time avatar and the pre-recorded avatar comprises identifying deviation between an anatomical landmark on the real-time avatar and a corresponding anatomical landmark on the pre-recorded avatar.

18. The method of claim 13 wherein sensing the patient's movement during an exercise session comprises sensing the patient's movement outside the presence of an exercise prescriber.

19. A system for tracking exercise accuracy, the system comprising:
a motion or body sensing device configured to detect a patient's body position and generate movement data based on the patient's body position over time;
a physical computer-readable storage medium having stored thereon instructions executable by a device to cause the device to generate an avatar recording based on the movement data; and
a display device configured to display the avatar recording overlaid with an exemplary exercise avatar.

20. The system of claim 19, wherein the instructions further cause the device to detect deviation between the stored avatar and the exemplary exercise avatar.

21. The system of claim 20 wherein the instructions further cause the device to generate a report including at least one of the movement data, the deviation, or the avatar recording.

22. The system of claim 21, further comprising a transmitter configured to transmit the report to at least one of an exercise prescriber or health care provider.

23. The system of claim 22, further comprising a computing device remote from the physical computer-readable storage medium and configured to receive the transmitted report and display the report to the exercise prescriber or health care provider.
